(19) United States
(12) Patent Application Publication
(10) Pub. No.: US 2011/0054062 A1
(43) Pub. Date: Mar. 3, 2011

(54) UV Pressure-Sensitive Adhesive for Stickers and Labels

(76) Inventors: Ronald F. DeSanto, JR., Darien, IL (US); Norma D. Kammerer, Bloomingdale, IL (US)

(21) Appl. No.: 12/869,363

(22) Filed: Aug. 26, 2010

Related U.S. Application Data
(60) Provisional application No. 61/237,187, filed on Aug. 26, 2009.

(51) Int. Cl. C08F 2/46

(52) U.S. Cl. 522/95

(57) ABSTRACT

A UV pressure-sensitive adhesive is described. In one aspect of the invention, the adhesive comprises a UV rosin-monomer blend, an acrylated urethane polyol, a TPDGA tripropylene glycol, a UV flexo photoinitiator, a nonionic wetting agent and molecular defoamer, and a slip additive and deaerator. In another aspect of the invention, the adhesive comprises a UV low odor rosin varnish, an acrylated urethane polyol, a TPDGA tripropylene glycol diacrylate, a multifunctional triacrylate monomer, a UV low odor photoinitiator, a nonionic wetting agent and molecular defoamer, a slip additive and deaerator, and a fragrance.

### PRIORITY

This application claims priority from U.S. Provisional Patent Application No. 61/237,187, filed Aug. 26, 2009, the disclosure of which is incorporated herein.

### BACKGROUND OF THE INVENTION

The present invention relates to printing materials in which a removable element is desired, such as stickers and dry peel cards or folds and flaps of advertisements.

### BRIEF SUMMARY OF THE INVENTION

The present invention comprises a UV pressure-sensitive adhesive. In one aspect of the invention, the adhesive comprises a UV rosin-monomer blend, an acrylated urethane aliphatic or aromatic polyol, a TPDGA tripropylene glycol, a UV flexo photoinitiator, a nonionic wetting agent and molecular defoamer such as the one sold under the trade name Surfynol 104, and a slip additive and deaerator. In another aspect of the invention, the adhesive comprises a UV low odor rosin varnish, an acrylated aliphatic urethane polyol, a TPDGA tripropylene glycol diacrylate, a multifunctional triacrylate monomer, a UV low odor photoinitiator, a nonionic wetting agent and molecular defoamer such as the one sold under the trade name Surfynol 104, a slip additive and deaerator, and a fragrance.

### DETAILED DESCRIPTION OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

### First Embodiment

In a first embodiment of the invention, the UV pressure-sensitive adhesive preferably comprises the following materials, mixed well, preferably in the following proportions:

| | |
|---|---|
| UV Rosin-Monomer Blend (preferably UFO-349) | 63.5 LB |
| Acrylated Urethane Aliphatic or Aromatic Polyol | 25.0 LB |
| (preferably Ebecryl 230) | |
| TPDGA Tripropylene Glycol Diacrylate | 2.0 LB |
| (preferably Etermer-223) | |
| UV Flexo Photoinitiator (preferably UFO-279) | 7.5 LB |
| Surfynol 104 (preferably UFO-325) | 1.0 LB |
| Slip Additive and Deaerator (preferably Tego Rad 2500) | 1.0 LB |

The proportions stated can be varied plus-or-minus 15 percent, preferably plus-or-minus 10 percent.

The UV Rosin-Monomer Blend preferably comprises the following materials, mixed well until clear, preferably in the following proportions:

| | |
|---|---|
| 18WR40 Semi-Solid Stabilized Rosin Ester | 30.0 LB |
| (preferably Sylvatac Re40) | |
| Monofunctional Aromatic Acrylate (preferably Photomer-4003) | 69.8 LB |
| Inhibitor Compound Blend (preferably Omnistab IN-516) | 0.2 LB |

The UV Rosin-Monomer Blend should be heated to 140° F. before mixed to make the UV pressure-sensitive adhesive. The proportions stated can be varied plus-or-minus 15 percent, preferably plus-or-minus 10 percent.

### Second Embodiment

In another embodiment of the invention, the UV pressure-sensitive adhesive contains fragrance oil. The inventors have found, surprisingly, that the following formulation blends well with fragrance oils, avoiding the need for microencapsulated fragrances. The use of the UV pressure-sensitive adhesive on folds and flaps of printed materials, or on stickers and dry peel cards, allows the fragrance to bloom upon opening the fold or flap or upon removal of the sticker or dry peel card.

This embodiment of the present invention preferably comprises the following materials, mixed well, preferably in the following proportions:

| | |
|---|---|
| UV Low Odor Rosin Varnish (preferably UFO-403) | 56.0 LB |
| Acrylated Urethane Aliphatic Polyol (preferably Ebecryl 230) | 21.0 LB |
| TPDGA Tripropylene Glycol Diacrylate | 1.75 LB |
| (preferably Etermer-223) | |
| Multifunctional Triacrylate Monomer (preferably Etermer 231) | 2.75 LB |
| UV Low Odor Photoinitiator (preferably UFO-348) | 6.5 LB |
| Surfynol 104 (preferably UFO-UFO-325) | 1.0 LB |
| Slip Additive and Deaerator (preferably Tego Rad 2500) | 1.0 LB |
| Cinnamon Fragrance ORC0600682 (preferably RCX-7001) | 10.0 LB |

The UV Low Odor Rosin Varnish of this embodiment preferably comprises the following materials, preferably in the following proportions:

| | |
|---|---|
| Stabilized Rosin Ester | 30.0 LB |
| (preferably Resigum V-100 or Sylvatac Re 85) | |
| Monofunctional Aromatic Acrylate | 69.8 LB |
| (preferably Photomer-4003) | |
| Inhibitor Compound Blend (preferably Omnistab IN-516) | 0.2 LB |

The UV Low Odor Rosin Varnish is preferably made by heating these materials to 185° F. until dissolved, then cooling to room temperature. The proportions stated can be varied plus- or-minus 15 percent, preferably plus-or-minus 10 percent.

The UV Low Odor Photoinitiator of this embodiment preferably comprises the following materials, preferably in the following proportions:

| | |
|---|---|
| Acrylated Benzophenone (preferably Ebercryl P36) | 1.00 lb |
| Diphenyl (2,4,6-Trimethylbenzoyl) | 0.27 lb |
| (preferably Aalchem PI-TPO) | |
| Acrylated Amine (preferably Etermen 6420) | 0.50 lb |
| Photo-Initiator 907 (preferably Aalchem PI-907) | 0.27 lb |
| Photo-Initiator 184 | 0.378 lb |
| (preferably Irgacure 184 or Aalchem PI-184) | |
| Photo Initiator (preferably Eterphoto-PI1173) | 0.162 lb |

The UV Low Odor Photoinitiator is preferably made by mixing these materials to 200° F. until fully dissolved.

The amount of fragrance used should be adjusted to achieve a desirable scent. The inventors have found a proportion of five to 18 percent to be best.

Other fragrances besides cinnamon can be used. Any fragrance, from a generic scent to a fine fragrance, can be used to achieve the desired effect from the end use. Any fragrant oil, including, for examples, water-soluble, oil-soluble, or alcohol soluble fragrant oils, can be used. While preferred embodiments of the present invention are shown and described, it is envisioned that those skilled in the art may devise various modifications of the present invention without departing from the spirit and scope of the appended claims.

We claim:

1. A UV pressure-sensitive adhesive comprising:
a UV rosin-monomer blend;
an acrylated urethane polyol;
a TPDGA tripropylene glycol;
a UV flexo photoinitiator;
a nonionic wetting agent and molecular defoamer; and
a slip additive and deaerator.

2. The UV pressure-sensitive adhesive of claim 1, wherein said adhesive comprises:
approximately 63.5 weight percent said UV rosin-monomer blend;
approximately 25.0 weight percent said acrylated urethane polyol;
approximately 2.0 weight percent said TPDGA tripropylene glycol;
approximately 7.5 weight percent said UV flexo photoinitiator;
approximately 1.0 weight percent said nonionic wetting agent and molecular defoamer; and
approximately 1.0 weight percent said slip additive and deaerator.

3. The UV pressure-sensitive adhesive of claim 2, wherein said UV rosin-monomer blend comprises a semi-solid stabilized rosin ester, a monofunctional aromatic acrylate, and an inhibitor compound blend.

4. The UV pressure-sensitive adhesive of claim 3, wherein said UV rosin-monomer blend comprises approximately 30.0 weight percent said semi-solid stabilized rosin ester, approximately 69.8 weight percent said monofunctional aromatic acrylate, and approximately 0.2 weight percent said inhibitor compound blend.

5. The UV pressure-sensitive adhesive of claim 1, wherein said UV rosin-monomer blend comprises a semi-solid stabilized rosin ester, a monofunctional aromatic acrylate, and an inhibitor compound blend.

6. The UV pressure-sensitive adhesive of claim 5, wherein said UV rosin-monomer blend comprises approximately 30.0 weight percent said semi-solid stabilized rosin ester, approximately 69.8 weight percent said monofunctional aromatic acrylate, and approximately 0.2 weight percent said inhibitor compound blend.

7. A UV pressure-sensitive adhesive, comprising:
a UV low odor rosin varnish;
an acrylated urethane polyol;
a TPDGA tripropylene glycol diacrylate;
a multifunctional triacrylate monomer;
a UV low odor photoinitiator;
a nonionic wetting agent and molecular defoamer;
a slip additive and deaerator; and
a fragrance.

8. The UV pressure-sensitive adhesive of claim 7, wherein said fragrance is cinnamon.

9. The UV pressure-sensitive adhesive of claim 7, wherein said fragrance is a generic scent.

10. The UV pressure-sensitive adhesive of claim 7, wherein said fragrance is a fine fragrance.

11. The UV pressure-sensitive adhesive of claim 7, wherein said fragrance is at least one of a water-soluble fragrant oil, an oil-soluble fragrant oil, and an alcohol-soluble fragrant oil.

12. The UV pressure-sensitive adhesive of claim 7, comprising:
approximately 56.0 weight percent said UV low odor rosin varnish;
approximately 17.5 weight percent said acrylated urethane polyol;
approximately 1.75 weight percent said TPDGA tripropylene glycol diacrylate;
approximately 3.5 weight percent said urethane acrylate oligomer;
approximately 2.75 weight percent said multifunctional triacrylate monomer;
approximately 6.5 weight percent said UV low odor photoinitiator;
approximately 0.75 weight percent said nonionic wetting agent and molecular defoamer;
approximately 0.25 weight percent said wetting agent;
approximately 1.0 weight percent said slip additive and deaerator; and
approximately 10.0 weight percent said water-soluble fragrance.

13. The UV pressure-sensitive adhesive of claim 12, wherein said fragrance is cinnamon.

14. The UV pressure-sensitive adhesive of claim 12, wherein said fragrance is a generic scent.

15. The UV pressure-sensitive adhesive of claim 12, wherein said fragrance is a fine fragrance.

16. The UV pressure-sensitive adhesive of claim 12, wherein said fragrance is at least one of a water-soluble fragrant oil, an oil-soluble fragrant oil, and an alcohol-soluble fragrant oil.

17. The UV pressure-sensitive adhesive of claim 9, wherein said UV low odor rosin varnish comprises a stabilized rosin ester, a monofunctional aromatic acrylate, and an inhibitor compound blend.

18. The UV pressure-sensitive adhesive of claim 17, wherein said fragrance is cinnamon.

19. The UV pressure-sensitive adhesive of claim 17, wherein said fragrance is a generic scent.

20. The UV pressure-sensitive adhesive of claim 17, wherein said fragrance is a fine fragrance.

21. The UV pressure-sensitive adhesive of claim 17, wherein said fragrance is at least one of a water-soluble fragrant oil, an oil-soluble fragrant oil, and an alcohol-soluble fragrant oil.

22. The UV pressure-sensitive adhesive of claim 17, wherein said UV low-odor rosin varnish comprises approximately 30 weight percent said stabilized rosin ester, approximately 69.8 weight percent said monofunctional aromatic acrylate, and approximately 0.2 weight percent said inhibitor compound blend.

23. The UV pressure-sensitive adhesive of claim 22, wherein said fragrance is cinnamon.

24. The UV pressure-sensitive adhesive of claim 22, wherein said fragrance is a generic scent.

25. The UV pressure-sensitive adhesive of claim 22, wherein said fragrance is a fine fragrance.

26. The UV pressure-sensitive adhesive of claim 22, wherein said fragrance is at least one of a water-soluble fragrant oil, an oil-soluble fragrant oil, and an alcohol-soluble fragrant oil.

27. The UV pressure-sensitive adhesive of claim 12, wherein said low odor photoinitiator comprises an acrylated benzophenone, a diphenyl (2,4,6-trimethylbenoyl), an acrylated amine, and a photoinitiator.

28. The UV pressure-sensitive adhesive of claim 27, wherein said fragrance is cinnamon.

29. The UV pressure-sensitive adhesive of claim 27, wherein said fragrance is a generic scent.

30. The UV pressure-sensitive adhesive of claim 27, wherein said fragrance is a fine fragrance.

31. The UV pressure-sensitive adhesive of claim 27, wherein said fragrance is at least one of a water-soluble fragrant oil, an oil-soluble fragrant oil, and an alcohol-soluble fragrant oil.

32. The UV pressure-sensitive adhesive of claim 7, wherein said UV low odor rosin varnish comprises a stabilized rosin ester, a monofunctional aromatic acrylate, and an inhibitor compound blend.

33. The UV pressure-sensitive adhesive of claim 32, wherein said fragrance is cinnamon.

34. The UV pressure-sensitive adhesive of claim 32, wherein said fragrance is a generic scent.

35. The UV pressure-sensitive adhesive of claim 32, wherein said fragrance is a fine fragrance.

36. The UV pressure-sensitive adhesive of claim 32, wherein said fragrance is at least one of a water-soluble fragrant oil, an oil-soluble fragrant oil, and an alcohol-soluble fragrant oil.

37. The UV pressure-sensitive adhesive of claim 32, wherein said UV low-odor rosin varnish comprises approximately 30 weight percent said stabilized rosin ester, approximately 69.8 weight percent said monofunctional aromatic acrylate, and approximately 0.2 weight percent said inhibitor compound blend.

38. The UV pressure-sensitive adhesive of claim 37, wherein said fragrance is cinnamon.

39. The UV pressure-sensitive adhesive of claim 37, wherein said fragrance is a generic scent.

40. The UV pressure-sensitive adhesive of claim 37, wherein said fragrance is a fine fragrance.

41. The UV pressure-sensitive adhesive of claim 37, wherein said fragrance is at least one of a water-soluble fragrant oil, an oil-soluble fragrant oil, and an alcohol-soluble fragrant oil.

42. The UV pressure-sensitive adhesive of claim 7, wherein said low odor photoinitiator comprises an acrylated benzophenone, a diphenyl (2,4,6-trimethylbenoyl), an acrylated amine, and a photoinitiator.

43. The UV pressure-sensitive adhesive of claim 42, wherein said fragrance is cinnamon.

44. The UV pressure-sensitive adhesive of claim 42, wherein said fragrance is a generic scent.

45. The UV pressure-sensitive adhesive of claim 42, wherein said fragrance is a fine fragrance.

46. The UV pressure-sensitive adhesive of claim 42, wherein said fragrance is at least one of a water-soluble fragrant oil, an oil-soluble fragrant oil, and an alcohol-soluble fragrant oil.
